(19) United States
(12) Patent Application Publication
(10) Pub. No.: US 2013/0207034 A1
(43) Pub. Date: Aug. 15, 2013

(54) SUBSTRATES FOR CARBON DIOXIDE CAPTURE AND METHODS FOR MAKING SAME

(71) Applicant: Corning Incorporated, (US)

(72) Inventor: William Peter Addiego, Big Flats, NY (US)

(73) Assignee: Corning Incorporated, Corning, NY (US)

(21) Appl. No.: 13/761,908

(22) Filed: Feb. 7, 2013

Related U.S. Application Data
(60) Provisional application No. 61/596,807, filed on Feb. 9, 2012.

(51) Int. Cl. B01J 20/28; B01J 20/30

(52) U.S. Cl. CPC B01J 20/28045; B01J 20/28061; B01J 20/28054; B01J 20/305
USPC 252/184; 264/177.12

(57) ABSTRACT

An absorbent structure for CO₂ capture includes a honeycomb substrate having a plurality of partition walls extending in an axial direction from an inlet end to an outlet end thereby forming a plurality of flow channels. The honeycomb substrate comprises a powder component and a binder that are solidified. The absorbent structure also includes a functional mer group dispersed throughout the powder component of the partition walls of the honeycomb substrate. The functional mer group is positioned in and on the partition walls such that, when a gas stream containing CO₂ flows in the flow channels from the inlet end to the outlet end, the functional mer group absorbs the CO₂ by forming a coordinated bond that forms carbonate, bicarbonate, carbamates, or another coordinated or ionic compound with the CO₂.

This application claims the benefit of priority under 35 U.S.C. §119 of U.S. Provisional Application Ser. No. 61/596,807 filed on Feb. 9, 2012 the content of which is relied upon and incorporated herein by reference in its entirety.

### BACKGROUND

1. Field

The present specification generally relates to absorbent structures for capturing carbon dioxide (CO₂) from a gas stream and, more specifically, to absorbent structures that are formed from a powder component and a functional mer group dispersed throughout the powdered component and activated to absorb CO₂.

2. Technical Background

CO₂ is a greenhouse gas that has been linked to global warming. CO₂ is a by-product of various consumer and industrial processes such as, for example, combustion of fossil fuels, purification of natural gas, oil recovery systems and the like. From an economic perspective, carbon trading and future regulations of carbon emissions from flue gases and other CO₂ point sources encourage the development of CO₂ capture technologies.

Various technologies are currently being used and/or developed to improve the capture of CO₂ from process gas streams. Such technologies include, for example, a liquid amine (MEA or KS-1) process, a chilled ammonia process, and gas membranes. While each of these technologies is effective for removing CO₂ from a process gas stream, each technology also has drawbacks. The chilled ammonia process is still in its early phases of development and the commercial feasibility of the process is not yet known. Some possible challenges with the chilled ammonia process include ammonia volatility and the potential contamination of the ammonia from gaseous contaminants such as SO_{X} and NO_{R}. Various gas membrane technologies are currently employed for the removal of CO₂ from process gas streams. However, processes utilizing gas membrane technologies require multiple stages and/or recycling in order to achieve the desired amount of CO₂ separation. These multiple stages and/or recycling add significant complexity to the CO₂ recovery process as well as increase the energy consumption and cost associated with the process. Gas membrane technologies also typically require high pressures and associated space constraint which makes use of the technology difficult in installations with limited space such as offshore platforms.

Accordingly, a need exists for alternative methods and apparatuses which may be used to recover CO₂ from process gas streams.

### SUMMARY

According to various embodiments, an absorbent structure for CO₂ capture includes a honeycomb substrate having a plurality of partition walls extending in an axial direction from an inlet end to an outlet end thereby forming a plurality of flow channels. The honeycomb substrate comprises a powder component and a binder that are solidified. The absorbent structure also includes a functional mer group dispersed throughout the powder component of the partition walls of the honeycomb substrate. The functional mer group is positioned in and on the partition walls such that, when a gas stream containing CO₂ flows in the flow channels from the inlet end to the outlet end, the functional mer group absorbs the CO₂ by forming a coordinated bond that forms carbonate, bicarbonate, carbamates, or another coordinated or ionic compound with the CO₂.

According to further embodiments, a method of forming an absorbent structure for CO₂ capture includes dry blending a powder component and a binder into a mixture, and adding a solution of a functional mer group and a solvent to the mixture to form a precursor, where the functional mer group absorbs CO₂ by forming a coordinated bond that forms carbonate, bicarbonate, carbamates, or other coordinated or ionic compound with CO₂. The method also includes mulling the precursor, extruding the precursor to form a consolidated monolith having a plurality of partition walls extending in an axial direction from an inlet end to an outlet end thereby forming a plurality of flow channels, and removing the solvent from the consolidated monolith to form a honeycomb substrate.

According to still further embodiments, a method of forming an absorbent structure for CO₂ capture includes forming a slurry comprising a powder component, a functional mer group, and a first solvent and removing the first solvent from the slurry to form individual grains of the powder component impregnated with the functional mer group, where the functional mer group absorbs CO₂ by forming a coordinated bond that forms carbonate, bicarbonate, carbamates, or other coordinated or ionic compound with CO₂. The method also includes blending a precursor comprising the impregnated individual grains of the powder component, a binder, and a second solvent, extruding the precursor to form a consolidated monolith having a plurality of partition walls extending in an axial direction from an inlet end to an outlet end thereby forming a plurality of flow channels, and removing the second solvent from the consolidated monolith to form a honeycomb substrate.

Additional features and advantages of the embodiments described herein will be set forth in the detailed description which follows, and in part will be readily apparent to those skilled in the art from that description or recognized by practicing the embodiments described herein, including the detailed description that follows, the claims, as well as the appended drawings.

It should be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts an absorbent structure for CO₂ capture having a honeycomb substrate according to one or more embodiments shown and described herein.

FIG. 2 is a photograph of an alumina extrudeate having a 400/6.5 monolith structure, 49% porosity and 130 m2/g surface area. The monolith is 4 inches in diameter and 6 inches in length.

FIGS. 3A and B are photographs of a honeycomb substrates formed from co-extruded silica gel and PEI, in a 600/3 monolith structure before (FIG. 3A) and after (FIG. 3B) eight test cycles in CO₂ steam.

FIG. 4 is a graph of Pore volume on the Y axis versus Pore Diameter (A) on the X axis, showing the pore size distribution of each silica gel as powder and the pore size distribution of the associated extrudate of silica gel monolith examples as shown in Table 1.

FIG. 5 is an equilibrium plot illustrating typical absorption in exemplary embodiments of coextruded silica gel-PEI honeycombs.

FIG. 6 is an equilibrium plot illustrating typical desorption of CO₂ in exemplary embodiments of coextruded silica gel-PEI honeycombs.

FIG. 7 is a graph showing low temperature desorption of CO₂ from embodiments of the substrates.

FIG. 8 is a graph presenting regenerated CO₂ as CO₂%/Temperature, C/CO₂ flow rate, (cc/minute)/cumulative CO₂, Std.-cc on the Y axis versus time on the X axis.

FIG. 9 is a graph presenting working capacity that shows cumulative absorbed CO₂ in cc/L versus time on the X axis.

FIG. 10 is a graph showing cumulative CO₂ desorption in cc/L on the Y axis compared to time on the X axis and temperature on the second Y axis.

FIG. 11 is a mercury intrusion porosimetry measurement, showing differential intrusion (in mg/g) on the Y axis versus pore size diameter on the X axis.

FIG. 12 is also a graph illustrating pore size distribution.

FIG. 13 is a graph illustrating pore size distribution of the JJW and IWC compositions with the same 200/7 geometry.

### DETAILED DESCRIPTION

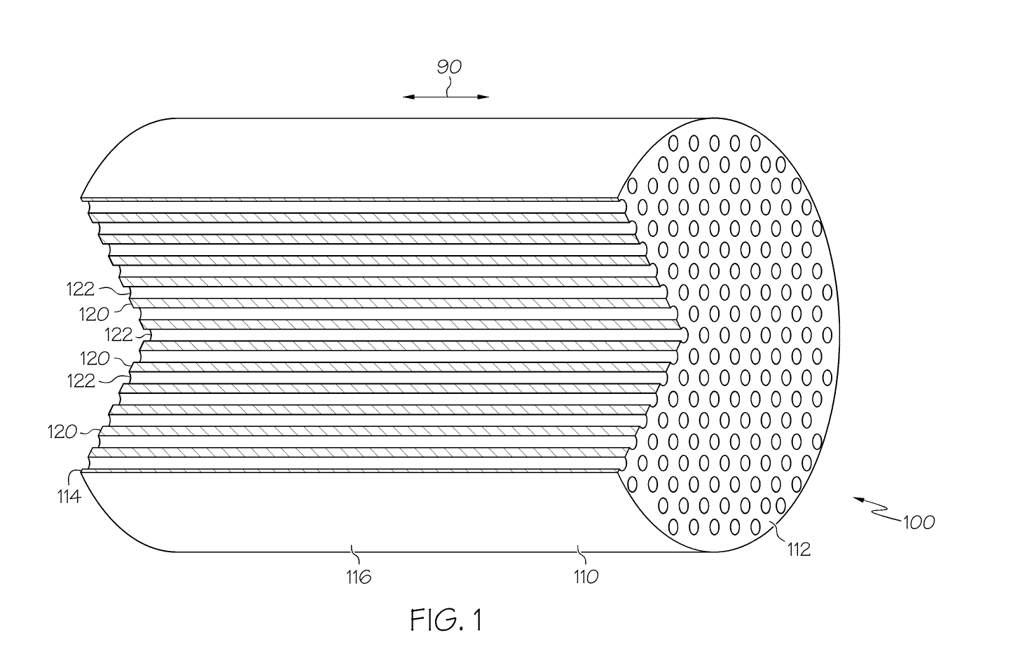

Reference will now be made in detail to embodiments of absorbent structures for capturing CO₂ from a gas stream and methods for forming the same, examples of which are illustrated in the accompanying drawings. Whenever possible, the same reference numerals will be used throughout the drawings to refer to the same or like parts. One embodiment of the absorbent structure for capturing CO₂ from a gas stream is schematically depicted in FIG. 1. The absorbent structure generally includes a honeycomb substrate or substrate structure having a plurality of partition walls extending in an axial direction from an inlet end to an outlet end, thereby forming a plurality of flow channels. The honeycomb substrate is formed from a powder component and a binder that are solidified into a consolidated monolith. A functional mer group is dispersed throughout the powder component that makes up the partition walls. The functional mer group is dispersed and stabilized throughout the partition walls of the honeycomb substrate. When a gas stream containing CO₂ flows in the flow channels, the functional mer group positioned within and constituting part of the wall surface comes into contact with the CO₂ and forms a bond to capture the CO₂ from the gas stream. The absorbent structure and methods of forming the absorbent structure will be described in more detail herein with specific reference to the appended drawings.

Referring now to FIG. 1, an absorbent structure 100 for CO₂ capture, alternatively referred to as a CO₂ contactor, is schematically depicted. The absorbent structure 100 includes a honeycomb substrate 110 having a plurality of partition walls 120 that extend in an axial direction 90 from an inlet end 112 to an outlet end 114. The plurality of partition walls 120 form a plurality of flow channels 122 though which a gas stream may flow. A skin 116 defines the outer diameter of the honeycomb substrate 110.

The honeycomb substrate 110 is formed from a powder component and a binder that form the partition walls 120 defining the flow channels 122. The powder component may include, but is not limited to, a high surface area and porous inorganic solid, for example alumina, silica, titania, amorphous and crystalline silicates, or combinations thereof and high surface area carbides such as high surface area silica carbide and other high surface area porous non-oxide inorganic solids. The power component may also support and stabilize the CO₂ absorbing compound. Before processing the powder component into the final form of the honeycomb substrate 110, the functional mer group may be introduced to the powder component using conventional methods. In the final form, the honeycomb substrate 110 further includes a functional mer group that is dispersed on and throughout the powder component of the partition walls 120. The functional mer group may also be cross-linked throughout the partition walls 120. When a gas stream is introduced to the inlet end 112 of the absorbent structure 100 and directed through the flow channels 122, the activated functional mer group reacts with the CO₂ in the gas stream and forms a coordinated bond with the CO₂, which creates carbonate, bicarbonate, carbamates, or other coordinated or ionic compounds, thereby absorbing the CO₂ from the gas stream.

In the embodiments of the honeycomb substrate 110 described herein, the powder component may include an inorganic oxide. The inorganic oxide may include, for example, non-refactory alumina, an inorganic molecular silicate, a non-crystalline amorphous silica, a double-layered hydroxide, or combinations thereof. Examples of non-refractory alumina include, but are not limited to, boehmite, γ-alumina, and similar transition alumina phases including amorphous ρ-alumina. Examples of non-crystalline amorphous silica include, but are not limited to, precipitated silica, silica gel, and mesoporous silica. In one embodiment, the inorganic oxide may be a zeolite, including, for example, faujasites, or β-type, X-type, A-type, or MFI-type zeolites. The powder component may also include activated carbon either by itself or in combination with one or more inorganic oxides.

The honeycomb substrate is formed from the powder component and a binder. In one embodiment, the binder is an organic compound that is a dispersible or soluble solid that has strength properties sufficient to maintain the shape of the honeycomb substrate for low-stress, low-temperature applications, such that sintering of the honeycomb substrate is unnecessary. The use of an unsintered powder component to form the honeycomb substrate results in a honeycomb substrate having a high surface area and porosity as compared with the overall dimensions of the honeycomb substrate. The organic binder, such as cellulosics, polyethylene glycols and polyethylene oxides, polyvinyl compounds, polyvinyl pyrrolidones, and other polymers, also provides rheological performance to promote and maintain the substrate structure upon forming, as will be discussed in more detail below. The binder typically remains in the honeycomb after extrusion and subsequent processing. Further, in some embodiments, the binder includes a material that absorbs CO₂.

Embodiments according to the present disclosure may utilize a variety of materials for the binder including organic and inorganic binders. Examples of such binders include organic solids such as the cellulosics methyl cellulose, hydroxyethyl cellulose and other cellulosics, Arabic gum, alginates, polymer binders such as vinyl acetate, acrylates, acrylic and vinyl latexes, thermoset polymers, such as phenolic resins, various monomers that could be polymerized in situ, polymers that can be cross-linked in situ, as well as silicones, alkoxides, and various clays, and other inorganic salts and materials, such as aluminum oxyhydroxide (boehmite), sodium silicate, and the like, as conventionally know.

The powder component is processed prior to the manufacture of honeycomb substrate 110 to provide the desired surface area, as will be described below. In some embodiments, the powder component may be milled such that the resulting particle size distribution of the powder component promotes poor particle packing, yielding high interstitial and inter-granular porosity that is less than 80% of the powder component's theoretical bulk density, for example, less than 50% of the powder component's bulk density. The surface area of the inorganic powder is greater than about surface area is greater than about 50 m²/g, for example, greater than about 150 m²/gram. In yet other embodiments, the inorganic powder component may be milled such that the surface area is from about 150 m²/gram to about 1000 m²/g, for example, from about 150 m²/g to about 800 m²/g. It should be understood that the increase in surface area of the powder component corresponds with a decrease in pore size of the processed honeycomb substrate 110. As such, the powder component incorporated into a honeycomb substrate 110 according to the present disclosure may have a mean pore size greater than about 2 nanometers. In some embodiments, the powder component may have a mean pore size greater than about 3 nanometers. In yet further embodiments, the powder component may have a mean pore size from about 4 nanometers to about 10 nanometers.

As will be discussed in further detail below, in general, increasing the surface area and optimal pore size of the powder component allows for greater dispersion of the functional mer group in and on the partition walls 120. However, as the pores decrease in size, the likelihood of “clogging” the pores with the functional mer group using convention coating techniques increases, reducing the total surface area of the functional mer group. Therefore, while not required by all embodiments disclosed herein, the disclosure includes the discovery of the optimal highest surface area and pore size distribution of the inorganic support material that can accommodate the distribution and disposition of the CO₂ absorbing functional mer group.

While the binder maintains the powder component in a pre-determined shape, the individual grains of the powder component are not fused to one another, and the porosity due to the individual grains of the powder component is not eliminated in the honeycomb substrate 110. As such, the honeycomb substrate 110 will continue to exhibit porosity through the thickness of the partition walls 120. In embodiments of the honeycomb substrate 110 according to the present disclosure, the honeycomb substrate 110 may have porosity greater than about 30%. For example, the honeycomb substrate 110 may have a porosity from about 20% to about 90%, for example a porosity from about 30% to about 80%.

To absorb CO₂, a functional mer group is dispersed throughout the powder component of the honeycomb substrate 110 such that the functional mer group is located in and on the partition walls 120. The phrase “in the partition walls” as used herein, means that the functional mer group is located around and in the pores of discrete particles of the powder component. The functional mer group of the polymer or monomer may be cross-linked both in and on the partition walls 120. The functional mer group may also be activated by cross-linking after the honeycomb substrate 110 is formed into a net or a near-net shape. The extent to which cross-linking of the functional mer group or polymerization of the functional mer group and subsequent cross-linking occurs is dependent on the inclusion of a cross-linking agent and/or a polymerizing agent. As discussed in more detail below, the cross-linking agent and/or the polymerization agent may be included with the extrusion composition. Alternately, the extent of cross-linking or polymerization of the functional mer group may depend on the propensity for cross-linking or polymerization when the functional mer group incorporated into the honeycomb substrate 110 is subjected to a thermal treatment. Once activated by cross-linking, the functional mer group absorbs CO₂ by forming a coordinated bond with the CO₂ that creates carbonate, bicarbonate, carbamates, or other coordinated or ionic compounds with the CO₂.

Examples of functional mer groups that absorb CO₂ include, but are not limited to, amine polymers, for example, polyethyleneimine (PEI), polyamidoamine (PAMAM), and polyvinyl amine. Examples of such compounds include tetraethylenepentamine, diethanolamine, diethylenetriamine, pentaethylenehexamine, as well as alkyaminoalkoxysilanes such as dimethylaminopropyltrimethoxysilane, among others. Embodiments according the present disclosure may include the use of any and all nirtogeneous-bearing organic compounds capable of absorbing CO₂ as a carbonate or carbamate or other species. The functional mer group according to the present disclosure, for example polyethyleneimine, may have a molecular weight from about 600 Da to about 10,000 Da.

As referred to above, when using conventional coating techniques, the high surface area of the powder component may prevent the even distribution of the functional mer group after the powder component is processed into a consolidated monolith shape. For example, when the pore sizes of the powder component are small as compared to the length of the functional mer group, the functional mer group may tend to clog the pores, closing off the pores from a gas stream. Clogged pores reduce the efficacy of the absorbent structure 100 in capturing CO₂ because the clogged pores prevent access to functional mer groups within the thickness of the channel walls. In the embodiments described herein, alternative manufacturing processes are utilized that prevent the pores from being clogged and allow the functional mer group to be dispersed throughout the thickness of the channel walls without clogging the pores formed therein.

Methods for manufacturing the absorbent structure will now be described. In one embodiment, the powder component and the binder are mixed together in a dry blending operation. The ratio of the powder component to the binder may vary based on the desired rheological properties of the mixture in a subsequent extrusion process. Species have been tested at a ratio of wt. % powder component to wt. % binder from about 30:1 or 20:1 to about 1:1. Separately, the functional mer group in liquid or solid form is mixed with a solvent in a dilution operation to form a diluted solution of the functional mer group. In some embodiments, the solvent includes an organic solvent such as an alcohol or other organic liquid, including polar organic solvents that are prepared as a solution with the functional mer group. In other embodiments, the solvent is water. The ratio of the mer group to the solvent in the diluted solution is from about 10:1 to about 1:40. High dilution with an organic solvent or water may be desirable where the functional mer group is highly viscous and has a high molecular weight, thereby making even distribution with the powder component difficult. The diluted solution of the functional mer group and the solvent is added to the mixture of the powder component and the binder in a wetting operation to form a precursor. The precursor is mixed in a mulling operation to evenly distribute the binder and functional mer group around the individual grains of the powder component, and to impart the desired rheological properties for a subsequent extrusion process.

Optionally, the precursor may be homogenized prior to extruding into a honeycomb. The homogenization operation may include processing the precursor through an extrusion machine to work the precursor until the precursor has the desired rheological properties. The precursor is then extruded into a honeycomb shape and cut to length, thereby forming a consolidated monolith having a net or near-net shape. The consolidated monolith includes the solvent, the powder component, the functional mer group, and the binder.

The consolidated monolith is then dried to remove the solvent from the consolidated monolith resulting in a honeycomb substrate. In one embodiment, the drying process is performed in a hot air oven. In another embodiment, the drying process is performed in a microwave oven. In yet another embodiment, the drying process is performed in a relative humidity oven. By controlling a drying gradient of the consolidated monolith, uneven shrinkage of the consolidated monolith can be avoided. Further, control of the drying gradient may result in a honeycomb substrate 110 having an increased strength. In some embodiments, the outer diameter of the consolidated monolith (corresponding to the skin 116 of the honeycomb substrate 110 depicted in FIG. 1) may be wrapped with a vapor barrier, for example, PTFE or paper. The vapor barrier may reduce the drying gradient at positions near the outer diameter of the consolidated monolith, locations which are prone to dry at a faster rate. The drying rate is controlled to remove from about 20% to about 80-95% of the volatile solvent from the consolidated monolith at multiple processing temperature set-points, as required. Such processing temperature set-points are lower than the decomposition temperature or denaturing temperature of the functional mer group. In addition, such processing temperature set-points may not exceed 100° C. for a duration or dwell time as required to minimize part shrinkage and stress until a majority of the solvent (i.e., up to about 80 to 95%) has been removed.

With the solvent removed, the honeycomb substrate 110 may be processed to activate the functional mer group by polymerization of a monomer or cross-linking of a polymer, as required, to enable capture of CO₂ from a gas stream. The activation process cross-links the individual mers of the functional mer group. Further, depending on the components of the functional mer group, the functional mer group may be activated by exposure to a polymerization agent or a cross-linking agent. Examples of such polymerization agent or cross-linking agents include, but are not limited to organic bi-functional agents such as dialdehydes or dicarboxylate salts, amides, co-polymers and other agents compatible with the functional mer group to react and form a cross-linked and/or polymerized system. In one embodiment, the polymerization agent is exposed to the functional mer group by introducing a solution or an aerosolized fog containing the polymerization agent or the cross-linking agent to the honeycomb substrate 110. In another embodiment, the polymerization agent or the cross-linking agent is added to the mixture containing the powder component and the binder in the dry blending operation. In this embodiment, the polymerization agent or the cross-linking agent is non-reactive with the components of the consolidated monolith 260 during the initial processing steps. However, when the consolidated monolith is dried, the elevated temperature initiates a reaction between the polymerization agent or the cross-linking agent and the functional mer group. Thus, the activation process may be incorporated into the drying process that removes the solvent from the consolidated monolith 260.

In another embodiment of a manufacturing process for forming the honeycomb substrate 110, the powder component, the functional mer group, and a first solvent are mixed into a slurry. The first solvent may be an organic solvent, such as an alcohol solution, or water. The slurry may be highly liquidous to encourage good mixing of the individual grains of the powder component with the functional mer group. In addition, surfactants and dispersants may be added to the slurry to assist with wetability of the functional mer group in the powder component. Further, polymerization agents or cross-linking agents may be added to the slurry for activation of the functional mer group. The slurry is then processed in a drying operation, which evaporates the first solvent from the solid components of the slurry. The drying operation results in individual grains of the powder component being impregnated with the functional mer group, and promote polymerization and/or cross-linking of the functional mer group where polymerization agents and/or cross-linking agents were added. Examples of such drying operations include, but are not limited to, introduction to a hot air oven, a spray-drying process, or a distillation process such as a rotary evaporator.

The impregnated individual grains of the powder component are blended with the binder and a second solvent in a wetting operation to form a precursor. Similar to the first solvent discussed above, the second solvent may be an organic solvent or water. The precursor is mixed in a mulling operation to evenly distribute the binder in and around the impregnated individual grains of the powder component, and to provide the desired rheological properties in the subsequent extrusion process. Additional mer groups may be added to the impregnated individual grains.

Optionally, the precursor may be homogenized. The homogenization operation may include processing the precursor through an extrusion machine to work the precursor until the precursor has the desired rheological properties. The precursor is then extruded into a honeycomb shape and cut to length, thereby forming a consolidated monolith having a net or near-net shape. The consolidated monolith includes the solvent, the impregnated individual grains of the powder component, and the binder.

The consolidated monolith is then dried and activated as described above to form an absorbent structure 100 suitable for the capture of CO₂.

In embodiments, the CO₂ absorbing organic material, either a polymer precursor, monomer or polymer with functional amines or similar groups to absord CO₂, either in solid or liquid form, is either dissolved or is diluted in water. The polymer tends to be ionic but is not exclusively ionic. In other words the polymer can be non-ionic. To this solution, additional materials can be added to improve the dispersability and wetability of the CO₂ absorbing compound, such as surfactants and dispersants, onto the high surface area support material which is typically certain inorganic compounds such as silica gel, other forms of silicas such as fumed silica, precipitated silica, etc., and silicates, transitional activated aluminas.

The silicas generally are amorphous but the silicates can be amorphous or crystalline. The alumina materials can be alumina hydroxides, alumina oxyhydroxides such as Boehmite, transition alumina, etc.

Separately, the high surface area inorganic material is mixed with an organic binder such as a cellulosic or inorganic binders or other compounds known in the art as binders.

In one embodiment, the green organic binder is a cellulosic hydrocolloid such as methyl cellulose. The high surface area inorganic oxide is mixed with the cellulosic binder. Then to this mixture, the CO₂ absorbing organic aqueous solution is added and mulled. This is a batch material. After sufficient time to ensure uniform mixing, this material is homogenized in the extruder and then cellular monoliths are extruded.

In embodiments, extruded substrate is not calcined or fired at high temperatures. The part can be dried at no greater than 120 degrees. Parts may be dried at less than 100 degrees.

The batch material can be further processed as a coating on any suitable substrate including monoliths, self-supporting mesh, spiral wound, and corrugated or assembled structures. The structure is the form factor. While this work employs a polymer suitable for the absorption of CO₂, it is envisioned that it can be used to absorb other gasses such as sulfur oxide compounds, nitrogenous gasses, or other dissolved gasses with a suitable polymer or other absorbing agent. Absorption can include the formation of a chemical bond or a physical absorption.

For the purposes of absorbing CO₂, this work is not limited by the molecular weight of the polyethylene imine or other amines or other groups capable of reacting with CO₂. In other words, the PEI can come in a variety of molecular weights, can be linear or branched, and includes all of the aspects of polyallyl amines and polyalkyl amines.

CO₂ gas capture can include many applications including envisioned are industrial gas, natural gas and bio gas. Industrial gasses can be waste product effluent or can be a by-product from an industrial process. Or, industrial gasses can be a contaminant such as the removal of CO₂ from natural gas.

It should be understood that the components of the absorbent structure 100 according to the present disclosure are processed at various temperatures and pressures. However, in all embodiments, the maximum processing temperature of the components of the absorbent structures 100 according to the present disclosure is below the sintering temperature of the powder components. Therefore, the absorbent structures 100 remain un-sintered, and are instead bound together by the binder and functional mer group dispersed throughout the powder component.

The absorbent structures 100 according to the present disclosure capture CO₂ from a gas stream that flows through the absorbent structures 100. The quantity of CO₂ that can be captured by the absorbent structures 100 is finite, and is based on the availability of the activated functional mer group that is positioned on the partition walls 120. In general, the greater the surface area of the honeycomb substrate 110, the greater the amount of functional mer group positioned on partition walls 120, and the greater the volume of CO₂ that can be captured at any one time. In operation, the CO₂ captured by an absorbent structure 100 can be desorbed, such as by heating or the like, from that absorbent structure 100, thereby allowing the absorbent structure 100 to again capture CO₂.

### EXAMPLES

The methods for forming the absorbent structure described herein will be further clarified with reference to the following examples.

### Example 1

A batch of powder component was formed from SASOL™ SBa200 γ-alumina (SASOL, Houston Tex.) with a surface area of approximately 212 m²/g was milled to a mean particle size of 22 μm. Approximately 500 grams of the γ-alumina was turbula-mixed with 10 wt. % super addition (50 grams) of CULMINAL™ (Ashland, Inc., Ashland, Ky.) methyl cellulose.

From the dry blended mixture, 10 wt. % super addition (50 grams) of polyethyleneimine (PEI) having a molecular weight of 1800 Da was thoroughly mixed into solution with 100-200 grams of batch water. The solution was added to the dry blended mixture and mulled, forming the precursor. To achieve the desired consistency and texture of a precursor, typically 60-65 wt. % super addition (approximately 300 grams) of batch water was added to the dry blended mixture of γ-alumina and CULMINAL™ methyl cellulose. The remaining batch water was added to the precursor as needed based on the desired consistency and texture of the precursor.

The precursor was homogenized by passing the precursor through a ram extruding machine to form a string or rope-like structure. After homogenization, the precursor was extruded to form the consolidated monolith. Two configurations of the consolidated monolith were evaluated. The first configuration consisted of a consolidated monolith having about 800-900 flow channels (or “cells”) per square inch of the inlet end, where the flow channels were defined by walls (alternatively referred to as “webs”) having a minimum thickness from about 0.002 to about 0.0035 inches. The second configuration consisted of a consolidated monolith having about 150-200 flow channels per square inch of the inlet end, where the flow channels were defined by walls having a minimum thickness from about 0.006 to about 0.009 inches. Both configurations of the consolidated monoliths were furnace dried at set temperatures of between 40° C. and 70° C. to evaporate the water from the consolidated monolith, to solidify and dry the honeycomb substrate. The honeycomb substrates were ready to be used to absorb CO₂ without further polymerization or cross-linking steps.

The two configurations of the honeycomb substrates were tested for CO₂ absorption. The specimen having 150-200 flow channels per square inch was degassed in N₂ from room temperature to 110° C., with a dwell time of 30 minutes. While remaining in an N₂ environment, the specimen was cooled to 27° C. A gas stream having 10% CO₂ (balance gas N₂) was introduced at 500 cc/minute. The CO₂ absorption was monitored by Fourier Transform Infrared (FTIR) spectroscopy. After saturation (resulting in approximately 100% CO₂ break-through, the specimen was flushed with pure N₂ for 30 minutes. The specimen was then heated in N₂ to desorb the CO₂ from the specimen. Desorption was also monitored by FTIR. The specimen absorbed and desorbed 3.2 mmoles and 2.7 mmoles of CO₂/g-PEI, respectively, over the two test cycles.

The specimen having 800-900 flow channels per square inch was subjected to the same test parameters as the specimen having 150-200 flow channels. The specimen having 900 flow channels per square inch absorbed and desorbed 3.7 and 3.1 mmoles of CO₂/g-PEI over the two test cycles.

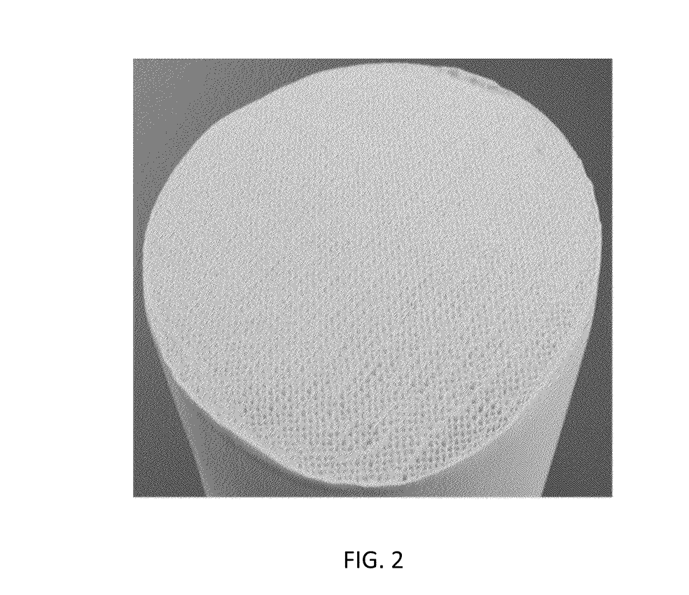

FIG. 2 is a is a photograph of an alumina extrudate having a 400/6.5 monolith structure, 49% porosity and 130 m2/g surface area. In describing a monolith as a “400/6.5” the first number is cell density in cells per square inch and the second number is the thickness of the wall in thousandths of an inch or mils. The monolith is 4 inches in diameter and 6 inches in length.

### Example 2

A batch of powder component was formed from SASOL™ SBa200 γ-alumina with a surface area of approximately 212 m²/g milled to a mean particle size of 22 p.m. The γ-alumina was mixed with silica gel with a surface area from about 350 to about 400 m²/g and a mean particle size of 21 μm at a ratio of 75 wt. % γ-alumina to 25 wt. % silica gel. The γ-alumina and silica gel mixture was dry blended with 10 wt. % super addition of CULMINAL™ methyl cellulose.

A solution containing batch water and a 10 wt. % super addition of PEI having a molecular weight of 1800 Da was added to the dry blended mixture forming a precursor. The precursor was processed according the parameters described above and extruded to form two configurations. The first configuration consisted of a consolidated monolith having about 800-900 flow channels per square inch of the inlet end, where the flow channels were defined by walls having a minimum thickness from about 0.002 to about 0.0035 inches. The second configuration consisted of a consolidated monolith having about 150-200 flow channels per square inch of the inlet end, where the flow channels were defined by walls having a minimum thickness from about 0.006 to about 0.009 inches. Both configurations of the consolidated monoliths were furnace dried at set temperatures of between 40° C. and 70° C. to evaporate the water from the consolidated monolith, and to solidify and dry the honeycomb substrate. The honeycomb substrates were ready to be used to absorb CO₂ without further polymerization or cross-linking steps.

The two configurations of the honeycomb substrates were tested for CO₂ absorption. Both specimens were degassed in N₂ from room temperature to 110° C., with a dwell time of 30 minutes. While remaining in an N₂ environment, the specimens were cooled to 27° C. A gas stream having 10% CO₂ (balance gas N₂) was introduced at 500 cc/minute. The CO₂ absorption was monitored by FTIR. After saturation (resulting in approximately 100% CO₂ break-through, the specimens were flushed with pure N₂ for 30 minutes. The specimen were then heated in N₂ to desorb the CO₂ from the specimen. Desorption was also monitor by FTIR. The specimens absorbed and desorbed 5.1 mmoles CO₂/g-PEI over the two test cycles.

### Example 3

A batch of powder component was formed from SASOL™ SBa200 γ-alumina with a surface area of approximately 212 m²/g was milled to a mean particle size of 22 p.m. The γ-alumina was mixed with silica gel with a surface area from about 350 to about 400 m²/g and a mean particle size of 21 μm at a ratio of 50 wt. % γ-alumina to 50 wt. % silica gel. The γ-alumina and silica gel mixture was dry blended with 10 wt. % super addition of CULMINAL™ methyl cellulose.

A solution containing batch water and a 10 wt. % super addition of PEI having a molecular weight of 1800 Da was added to the dry blended mixture forming a precursor. The precursor was processed according the parameters described above and extruded to form two configurations. The first configuration consisted of a consolidated monolith having about 800-900 flow channels per square inch of the inlet end, where the channels are defined by walls having a minimum thickness from about 0.002 to about 0.0035 inches. The second configuration consisted of a consolidated monolith having about 150-200 flow channels per square inch of the inlet end, where the channels are defined by walls having a minimum thickness from about 0.006 to about 0.009 inches thick. Both configurations of the consolidated monoliths were furnace dried at set temperatures between 40° C. and 70° C. to evaporate the water from the consolidated monolith, and to solidify and dry the honeycomb substrate. The honeycomb substrates were ready to be used to absorb CO₂ without further polymerization or cross-linking steps.

The two configurations of the honeycomb substrates were tested for CO₂ absorption. Both specimens were degassed in N₂ from room temperature to 110° C., with a dwell time of 30 minutes. While remaining in an N₂ environment, the specimens were cooled to 27° C. A gas stream having 10% CO₂ (balance gas N₂) was introduced at 500 cc/minute. The CO₂ absorption was monitored by FTIR. After saturation (resulting in approximately 100% CO₂ break-through, the specimens were flushed with pure N₂ for 30 minutes. The specimens were then heated in N₂ to desorb the CO₂ from the specimen. Desorption was also monitor by FTIR. The specimens absorbed and desorbed 5.3 mmoles CO₂/g-PEI over the two test cycles.

It should now be understood that the absorbent structures and methods of manufacturing the same may be utilized to form an absorbent structure that is suitable for use in removing CO₂ from a gas stream. Specifically, the absorbent structures include honeycomb substrates that have high surface area partition walls. The high surface area allows for placement of a large amount of a functional mer group for CO₂ adsorption along the partition walls thereby allow for improved CO₂ absorption capacity.

### Example 4

In embodiments, a type-C silica gel, described as a wide-pore silica gel, is ground to have a particle size distribution such that the median particle size is 22 um. The particle size can be bi-modal or multi-modal. To the silica gel is add 10 wt % super addition methylcellulose and is dry-blended. To the dry-blended powder 54% super addition of a polyethyleneimine (PEI) with an average molecular weight of 600-800 g/mol is diluted with water in a 1:1 ratio by mass. After aging with constant stirring, the solution is added to the powder and mulled to an extrudable consistency with additional water, as necessary. The material is then homogenized in an extruder. After homogenization, the material is extruded into cellular monoliths of various cell gometries, beads, pellets, and ribbons, of various geometries, or other structures and form factors. The extrudates are dried at temperatures <200° C., <110° C., or <70° C. The articles formed can be dried in a microwave, induction, hot-air, or relative humidity dryer, or other oven that serves to dry the articles. This example generally describes the composition of polymer with silica gel.

While this example describes a type-C silica gel, other types of silica or alumina may be used. Combination of silica of various types can be mixed together or generated during the process. Silica can be mixed with various transition alumina materials, including boehmite, amorphous alumina, rho, gamma-alumina, and other porous alumina species. Other organic and inorganic additives to improve dispersion of the organic amine an CO₂ capture are included, such as surfactants and dispersants to improve dispersion of the polymer, and thermally cross-linkable polymers to improve strength water insolubility.

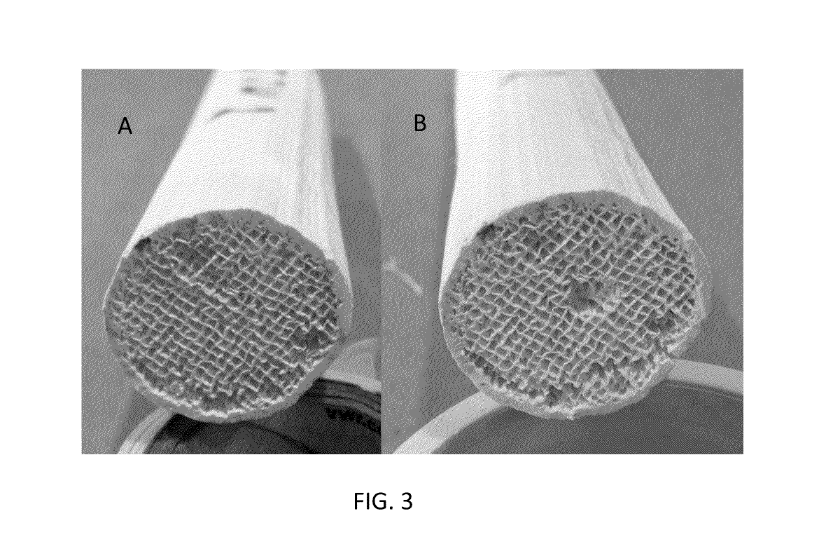

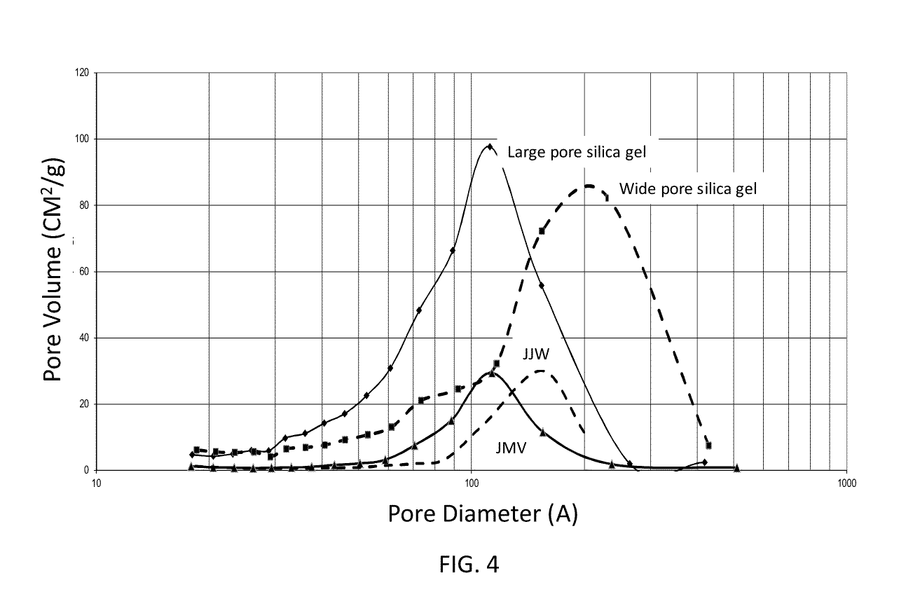

FIGS. 3A and B are photographs of a honeycomb substrates formed from co-extruded silica gel and PEI, in a 600/3 monolith structure before (FIG. 3A) and after (FIG. 4B) eight test cycles according to formulation JJW, Example 4. As can be seen in FIGS. 3A and B, the structure remains intact after repeated heating and cooling absorption/desorption cycles with CO₂ and steam. The monolith retains its mechanical integrity. The structure is stable despite not being calcined. even when treated with multiple absorption/desorption cycles with CO₂ and steam. In additional embodiments, laminates, spirals, pellets, beads, and ribbons, and other geometries and form factors suitable for extrusion may also be made, including particles sufficiently small and with appropriate shape so as to support operation as a fluidized bed. In addition, the batch material can be drawn or spun or by other means made into fibers, with can be short fibers or long fibers. With additional processing such as the inclusion of cross-linkable organic binders (although cross-linkers are not necessary), such fibers can be spun into a self-supporting mesh.

### Example 5

500 g of type-C silica wide-pore silica gel obtained from Alfa Aesar (Ward Hill, Mass.) is mixed with 50 g of CULMINAL methyl cellulose. Separately, 269 g of PEI with an average molecular weight of 680 g/mol is diluted in 269 g of water with constant stirring. After several hours and at ambient temperature, the PEI-water solution is added to the powder with constant mixing, such as in a muller. Additional water is added such as to obtain a suitably plastic material for extrusion. The material is homogenized in the extruded to create a consolidated batch material; the process is repeated several times. The material is then extruded into the final articles and dried. This example is shown in Table 1 as “JJW”.

### Example 6

500 g of type-C silica large-pore silica gel obtained from Alfa Aeser is mixed with 50 g of CULMINAL™ methyl cellulose. Separately, 269 g of water is mixed with a 8 g of surfactant/dispersant, sorbitan mono oleate. To this solution, 269 g of PEI with an average molecular weight of 680 g/mol is diluted in 269 g of water with constant stirring. After several hours and at ambient temperature, the PEI-water solution is added to the powder with constant mixing, such as in a muller. Additional water is added such as to obtain a suitably plastic material for extrusion. The material is homogenized in the extruded to create a consolidated batch material; the process is repeated several times. He material is then extruded into the final articles and dried. This example is shown in Table 1 as “JMV”.

### Example 7

500 g of a gamma-alumina SBa-200 obtained from SASOL is mixed with 50 g of CULMINAL™ methyl cellulose. Separately, 269 g of PEI with an average molecular weight of 680 g/mol is diluted in 269 g of water with constant stirring. After several hours and at ambient temperature, the PEI-water solution is added to the powder with constant mixing, such as in a muller. Additional water is added such as to obtain a suitably plastic material for extrusion. The material is homogenized in the extruded to create a consolidated batch material; the process is repeated several times. He material is then extruded into the final articles and dried. Example 7 is similar to Example 1, except that there is more polymer present and the polymer is a lower molecular weight.

### Example 8

500 g of type-C silica wide-pore silica gel obtained from Alfa Aesar is mixed with 50 g of CULMINAL™ methyl cellulose. Separately, 300 g of PEI with an average molecular weight of 680 g/mol is diluted in 300 g of water with constant stirring. After several hours and at ambient temperature, the PEI-water solution is added to the powder with constant mixing, such as in a muller. Additional water is added such as to obtain a suitably plastic material for extrusion. The material is homogenized in the extruded to create a consolidated batch material; the process is repeated several times. He material is then extruded into the final articles and dried. This example is similar to Example 4, except that there is more PEI (300 g instead of 269 g) present.

### Example 9

300 g of type-C silica wide-pore silica gel obtained from Alfa Aser and 200 g of gamma-alumina SBa200 from SASOL™ both with a median particle size of 22 um are mixed with 50 g of CULMINAL™ methyl cellulose. Separately, 269 g of PEI with an average molecular weight of 680 g/mol is diluted in 269 g of water with constant stirring. After several hours and at ambient temperature, the PEI-water solution is added to the powder with constant mixing, such as in a muller. Additional water is added such as to obtain a suitably plastic material for extrusion. The material is homogenized in the extruded to create a consolidated batch material; the process is repeated several times. The material is then extruded into the final articles and dried. Example 9 is similar to Examples 2 and 3, except that the silica gel is the majority component of the inorganic oxides and alumina is the minority component, and a lower molecular weight of PEI is used, in a larger amount, whereas in Example 2, 10% PEI is used in a 75% alumina/25% silica gel example.

### Example 10

In another example, 500 g of type-C silica wide-pore silica gel obtained from Alfa Aesar (Ward Hill, Mass.) is mixed with 50 g of CULMINAL methyl cellulose. Separately, 8 grams of sorbitan monooleate (this represents 3% as a percentage of PEI), a surfactant and dispersant, is added to 269 g of water. After stirring, 269 grams of PEI with an average molecular weight of 680 g/mol is diluted in the surfactant-water solution. After several hours and at ambient temperature, the PEI-water solution is added to the powder with constant mixing, such as in a muller. Additional water is added such as to obtain a suitably plastic material for extrusion. The material is homogenized in the extruded to create a consolidated batch material; the process is repeated several times. The material is then extruded into the final articles and dried. This example is shown in Table 1 as “KGK”. KGK is similar to JJW but was extruded with 3% sorbitan mono-oleate, as a percentage of the PEI amount, to help promote the dispersion of PEI on the silica gel, resulting in high CO₂ absorption capacity.

TABLE 1

| | Sample | | | | | | |
|---|---|---|---|---|---|---|---|
| | | | | | | | Capture |
| | Cell Density & | Monolith | CO₂ Adsorption | | CO₂ Desorption | | Efficiency |
| | Web Thickness | Density | Liter CO₂/ | Liter CO₂/ | Liter CO₂/ | Liter CO₂/ | mmol CO₂/ |
| Composition Code | cell/in²/mil | g/cc | Liter Monolith | Monolith* | Liter Monolith | Monolith* | g-PEI |
| JMV-1 | 200/7 | 0.314 | 7.35 | 24.98 | 7.62 | 25.90 | 3.47 |
| JMV-2 | 400/7 | 0.429 | 11.29 | 38.39 | 15.53 | 52.79 | 3.93 |
| JMV-3 | 400/7 | 0.374 | 17.24 | 58.61 | 15.78 | 53.66 | 6.65 |
| JJW1 | 200/7 | 0.474 | 10.28 | 34.97 | 11.34 | 38.55 | 3.16 |
| JJW2-1 | 200/7 | 0.258 | 9.06 | 30.81 | 7.90 | 26.85 | 5.61 |
| JJW3-1 | 400/7 | 0.361 | 15.22 | 51.73 | 13.87 | 47.16 | 6.33 |
| JJW3-2 | 200/7 | 0.269 | 10.19 | 34.64 | 9.87 | 33.56 | 5.97 |
| JJW3-AG-1 (aged in steam) | 400/7 | 0.367 | 15.51 | 52.74 | 14.40 | 48.95 | 6.43 |
| JJW4-1 | 400/7 | 0.352 | 18.39 | 62.53 | 17.36 | 59.02 | 7.58 |
| KGK-1 (with sorbitan mono- | 400/7 | 0.340 | 19.60 | 66.64 | 16.43 | 55.88 | 8.79 |
| oleate) | | | | | | | |

Table 1 shows the volume of CO₂ absorption and desorption per liter of monolith and per full-size 3.4 liter monolith (*CO₂ absorption and desorption volumes are measured as volume of CO₂ per 3.4 liter monolith) of compositions using two types of silica gel; JJW (from Example 5) and KGK (from Example 10) using a wide pore silica gel from Alfa Asear, and JMV (from Example 6) using a large pore silica gel also from Alfa Asear.

The graph shown in FIG. 4 shows the pore size distribution of each silica gel as powders which are wide pore and large pore silica gels, and the pore size distribution of the associated extrudate. The wide pore silica gel has a coarser pore size distribution and the large pore has a distribution towards finer pore sizes, as shown in FIG. 4. The JMV formulation is the large pore formulation and the JJW formulation is the wide pore formulation. The work shows that large volumes of CO₂ can be captured with the co-extruded composite monoliths. All samples are composed of 33% PEI with a molecular weight of 600 g/mol supported on a high surface area type-C silica gel. In embodiments, higher cell density monoliths can absorb and desorb more CO₂ than lower cell density monoliths. Table 1 shows that monolith density >0.2 g/cc is desired, or greater than 0.3 g/cc to exhibit very high CO₂ absorption capacity. In addition, Table 1 shows that the capture efficiency in mmol CO₂/g-PEI among the compositions is very high; generally, efficiencies >4 mmol CO₂/g-PEI are considered excellent. In JJW3-AG-1, the sample was aged in flowing steam at 110° C. for 24 hr and showed no degradation when compared with JJW3-1.

FIG. 4 is a graph of pore volume on the Y axis versus Pore Diameter (A) on the X axis, showing the performance of two of the silica gel examples (JJW and JMV) described above and shown in Table 1. The graph of FIG. 4 shows the pore size distribution of each silica gel as powder and the pore size distribution of the associated extrudate.

### Example 10

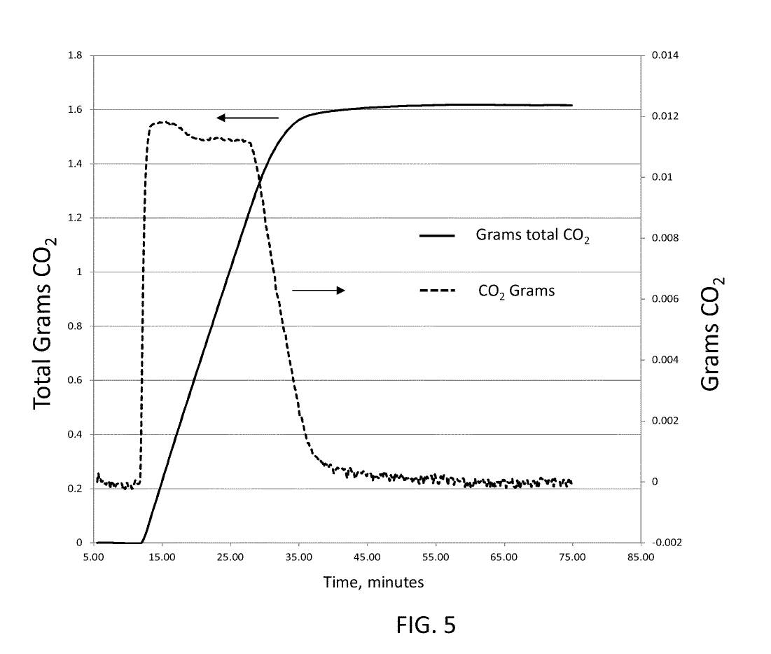

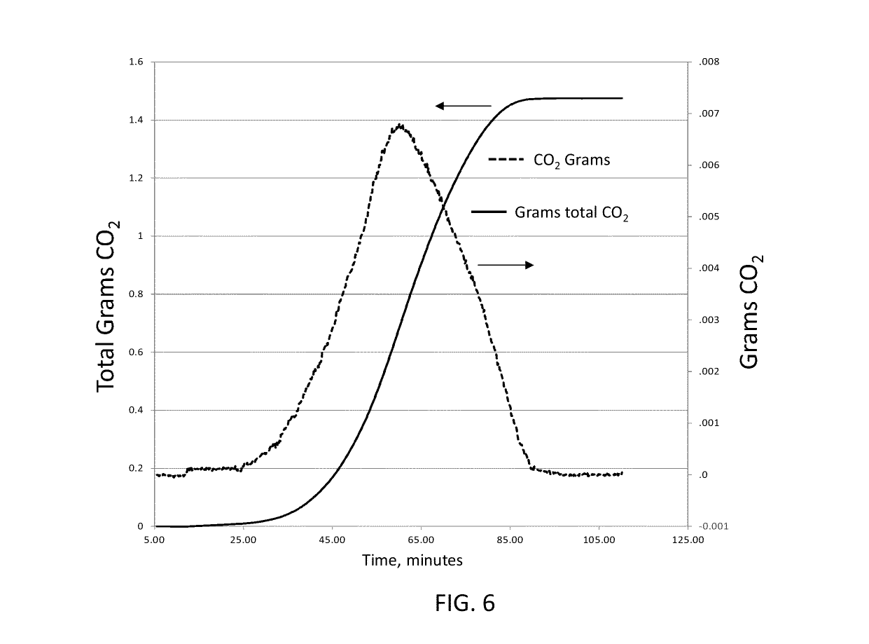

To test the absorption and desorption of samples, the sample is placed into a tubular reactor and N₂ gas is flowed through the honeycomb. The temperature is raised to 110° C. To degas the sample of CO₂ and other adsorbates. The sample is then cooled to room temperature where a gas mixture of 10% CO₂ in N₂ is introduced to the reactor at 500 cc/minute and the amount of CO₂ adsorbed was measured as shown in FIG. 5. The plot of total grams of CO₂ represents the cumulative amount of CO₂ absorbed by the sample during the test. The sample was absorbed to saturation. After absorption, the reactor chamber is purged of CO₂ with flowing N₂ gas. While the term “absorption” is used in this disclosure, this term can be used interchangeably with the term “adsorption”. Once the gas phase CO₂ is removed, the temperature is ramped to 110° C. in flowing N₂ at a ramp rate of 3.1 degrees per minute. At 110° C., the sample remains under these conditions for 30 minutes before it is cooled. During the desorption, the data is collected and plotted and shown in FIG. 6.

Honeycombs made according to the above examples were tested for CO₂ absorption and desorption. The example shown in FIGS. 5 and 6 represent absorption (FIG. 5) and desorption (FIG. 6) by the JJW formulation, described above in Example 5. While the figures show an absorption and desorption curve from a particular example, this is a representative example and the plots shown in FIGS. 5 and 6 were similar for alumina samples, and other samples.

FIGS. 5 and 6 are equilibrium plots illustrating typical absorption and desorption of CO₂. FIG. 5 shows typical CO₂ absorption of a coextruded PEI-silica gel composite 400/7 honeycomb. CO₂ is absorbed at 10% CO₂/N₂ at 500 cc/minute at ambient temperature to saturation (100% CO₂ breakthrough). The plot shown in FIG. 6 shows typical desorption of a coextruded PEI-silica gel composite 400/7 honeycomb. CO₂ is desorbed in N₂ at 500 cc/min, at temperature ramp of 3.1° C./min to 110° C. FIGS. 5 and 6 show that large volumes of CO₂ can be captured with the co-extruded composite monoliths.

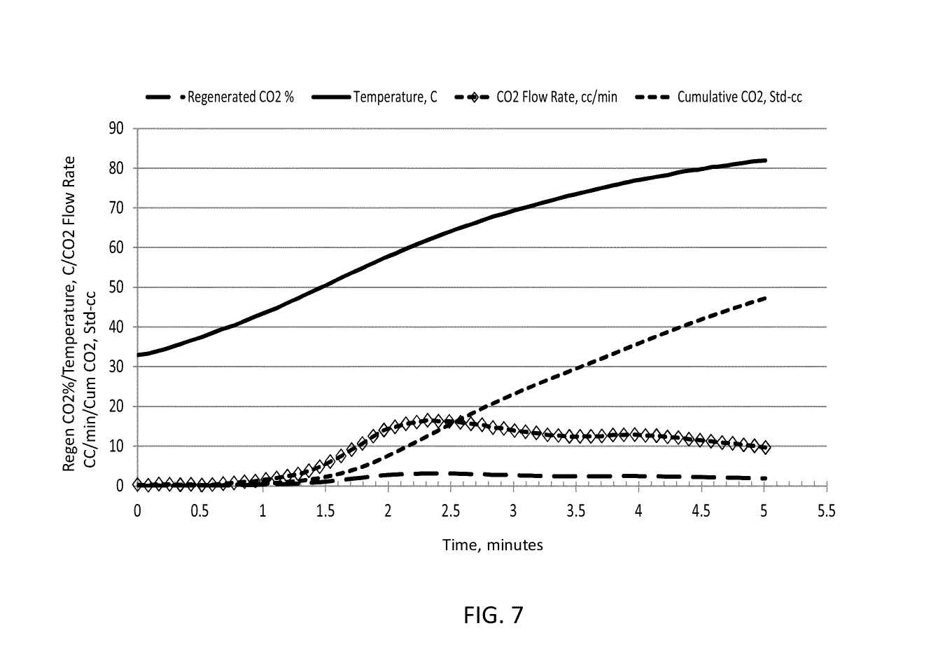

FIG. 7 is a graph showing low temperature (up to 80° C.) desorption of CO₂ from embodiments of the substrates. Under a kinetically limited absorption and desorption process, the CO₂ is desorbed in flowing N₂ gas, flowing at 500 cc/minute, showing the desorption as presented in FIG. 7. The early desorption of CO₂ from the absorber is an advantage of these embodiments, in that it allows for faster cycle time. FIG. 7 is a graph showing Regen CO₂%/temperature, ° C./CO₂ flow rate (cc/minute)/cumulative CO₂, Std.-cc (which means total volume of CO₂) on the Y axis versus time on the X axis. All samples are composed of 33% PEI with a molecular weight of 600 g/mol supported on a high surface area type-C silica gel. The data presented in FIG. 7 has not been normalized to monolith volume.

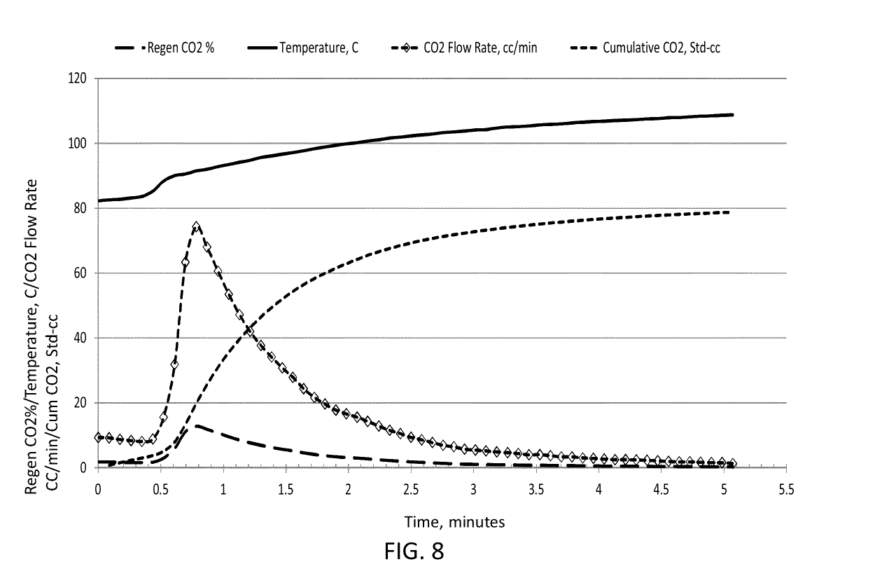

FIG. 8 is a graph presenting Regen CO₂%/temperature, ° C./CO₂ flow rate (cc/minute)/cumulative CO₂, Std.-cc on the Y axis versus time on the X axis. During desorption in steam (up to 110° C.), further increasing the temperature, the rest of the CO₂ rapidly desorbs from the sample. The data presented in FIG. 8 was not normalized to monolith volume. The advantage of embodiments disclosed herein is that there is early CO₂ desorption at relatively low temperatures, and rapid subsequent CO₂ desorption up to 110° C. FIG. 7 shows the early, low-temperature desorption feature, which is one aspect of this work; the advantage is potentially lower desorption cost and potentially a more efficient system. FIG. 8 shows desorption of CO₂ from the sample as it is heated in steam, exhibiting a very sharp desorption peak and indicating that desorption is complete within five minutes.

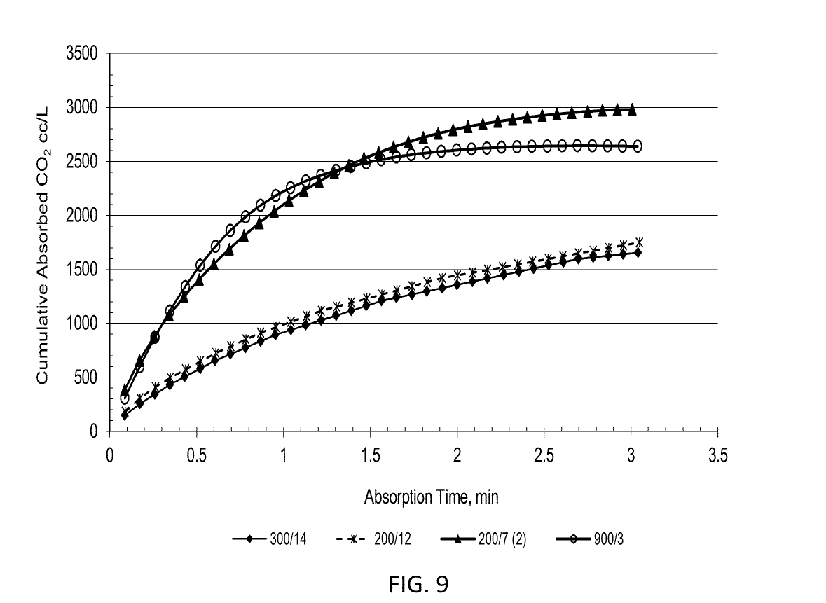

FIG. 9 is a graph showing cumulative CO₂ absorption in cc/L and time on the Y axis compared to time on the X axis. This graph shows how honeycomb geometry can effect CO₂ mass transfer resistance and limit the amount of CO₂ absorbed within three minutes. The thicker-webbed, denser monoliths, such as the 300/14 monolith, absorb less CO₂ than the thin webbed monoliths, such as the 200/7, even though these substrates have more PEI than exists in the 200/7 geometry. Monolith density is important, and it must be high enough to contain enough polymer (PEI) and support to provide sufficient CO₂ absorption capacity per unit volume. However, that increased density should be attained by higher cell density and appropriate web thickness that does not exhibit mass transfer resistance. FIG. 9 shows the effect of mass transfer resistance of the cellular geometry to kinetically limit the amount of CO₂ adsorbed within a specified amount of time. This is due to cellular webs (or walls) that are too thick. The graph also shows that when webs are thin enough, such as 3 mils in the 900 cpsi example geometry and 7 mils in the 200 cpsi geometry, there is little or no mass transfer resistance to CO₂ absorption that is observed.

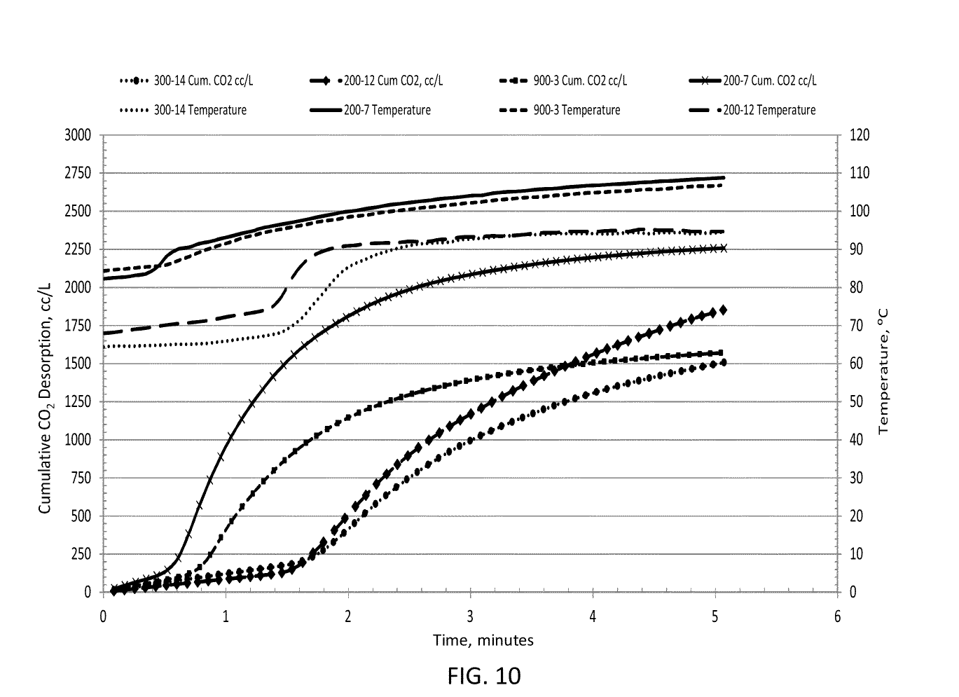

FIG. 10 is a graph showing cumulative CO₂ desorption in cc/L and time on the Y axis compared to time on the X axis. FIG. 10 shows the impact of higher thermal mass on delaying CO₂ desorption and the longer amount of time needed to increase the temperature in denser honeycombs with thicker webs. As shown in the FIG. 10, 200/7 and 900/3 geometries are hotter and CO₂ desorbs earlier than either the 300/14 or 200/12. The 200/7 and the 900/3 begin desorbing in less than half the time required to begin desorbing CO₂ from the thicker-walled honeycombs. In addition, the 200/7 and 900/3 examples generate a higher temperature faster than the 200/12 or the 300/14 geometries. The temperature profile begins after a pre-heat step in which the thermal mass inhibits the thicker-walled honeycombs from achieving the same initial temperature as the thinner-walled contactors. The thermal mass disadvantage of the thicker walled geometries carries through during the heat-up in steam.

In embodiments, in order to minimize mass transfer resistance and thermal mass, web thickness should be <25 mil, <10 mil, or <8 mil. Cell density should be <5000 cpsi, <2000 cpsi, <1000 cpsi, or <600 cpsi. In addition, the porosity of the web and the material of which the web is composed should have an open porosity >30%, >40%, or >50%.

In embodiments, higher cell density monoliths can absorb and desorb more CO₂ than lower cell density monoliths. In embodiments, geometric monolith density (calculated as the total bulk volume of the monolith)>0.2 g/cc is desired, and preferably >0.3 g/cc to exhibit very high CO₂ absorption capacity. In addition, in embodiments, the capture efficiency in mmol CO₂/g-PEI among the compositions is very high; generally, efficiencies >4 mmol CO₂/g-PEI are considered excellent. In JJW3-AG-1, the sample was aged in flowing steam at 110° C. for 24 hr and showed no degradation when compared with JJW3-1. KGK is similar to JJW but was extruded with 3% sorbitan mono-oleate, as a percentage of the PEI amount, to help promote the dispersion of PEI on the silica gel, resulting in high CO₂ absorption capacity.

A particular advantage of this work is that it provides high absorption capacity versus thermal mass of the substrates. Desorption of CO₂ occurs by means of heating the absorber to release CO₂. It is therefore important to minimize the thermal mass of the contactor while optimizing the use of heat to efficiently desorb CO₂. It is therefore important that the contactor have high CO₂ absorption capacity per unit volume per contactor and high absorption efficiency per mole of absorption polymer.

In embodiments, these examples demonstrate both of those characteristics. As a cellular monolith embodiment, this work demonstrates high CO₂ absorption capacity per unit volume of monolith and high CO₂ absorption efficiency per gram of PEI.

In order to get sufficient CO₂ capacity, there is a minimum form factor density necessary per unit volume. That is, the amount of contactor per unit volume must meet a minimum standard. For example, a minimum capacity could be for example, 15 L, 22 L, 30 L, 40 L or greater (for a full-size monolith which is a 3.4 L monolith, in embodiments). The ratio of minimum capacity to the geometric volume of the monolith which includes the channel space would change for a monolith of a different size.

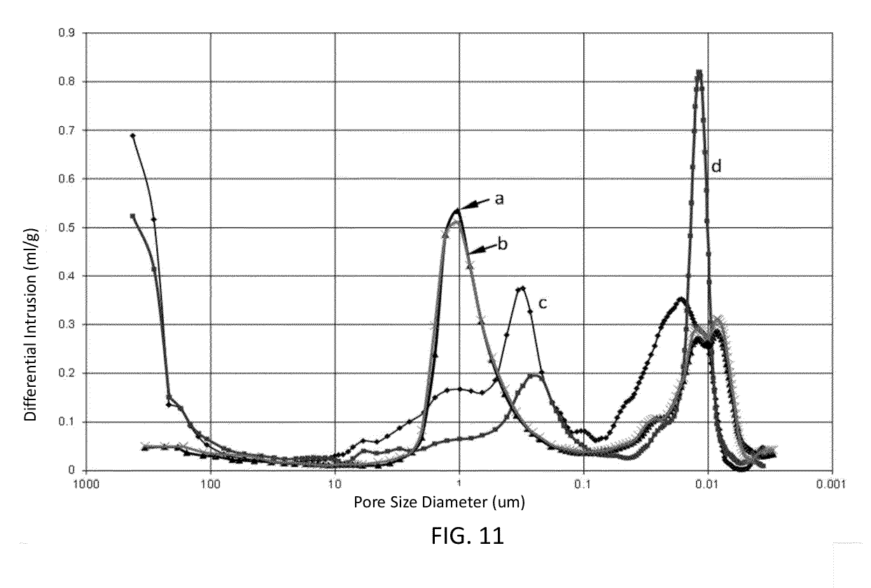

FIG. 11 is a mercury intrusion porosimetry measurement, showing differential intrusion (in ml/g) on the Y axis versus pore size diameter on the X axis. These measurements were made according to well known techniques. FIG. 11 shows that with the same amount of polymer, 54% super addition of 600 Da PEI, pore size distribution in the final product is affected by cell geometry and silica composition. (a) is JMV, 200/7; (b) is JMV, 400/7; (c) is JJW, 200/7 and (d) is JJW 600/3.5. In embodiments, controlling the pore size distribution with the selection of amorphous, high surface silica, its particle size distribution, PEI polymer loading, and cellular geometry is important. Controlling these parameters to affect the pore size distribution is an aspect of this work. As an example, plots a and b of the JMV composition show two different cell geometries but with the same web thicknesses, the pore size distributions overlap. However, with the JJW composition (c), with the 200/7 geometry, a different pore size distribution is obtained. Yet again in (d) with the 600/3.5 geometry another pore size distribution is obtained. Thus, controlling these parameters is possible, and may be important for obtaining a desired pore size distribution to optimize the kinetics of CO₂ absorption/desorption in these contactors, under rate limiting or kinetically limiting conditions.

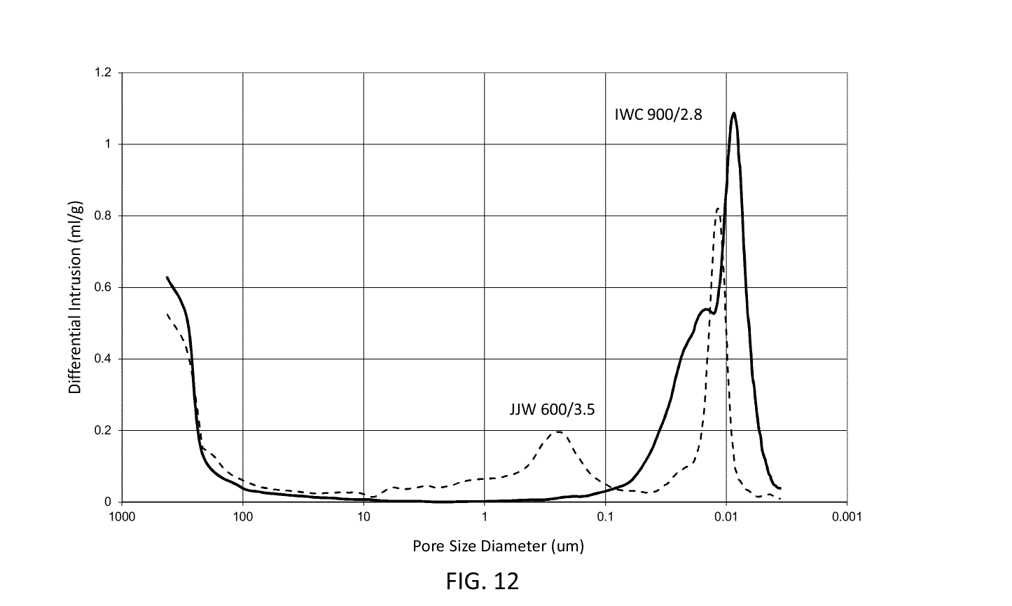

FIG. 12 is a graph illustrating pore size distribution. Shown in FIG. 12 is the effect of different cell geometries with thin webs, with two different polymer loadings. FIG. 12 shows the JJW formulation, having 44% porosity, 0.5 cc/g pore volume, in a 600/3.5 configuration, compared to an IWC formulation in a 900/2.8 configuration. Even with different cell densities and similar web thicknesses, differences in PEI loading alters the pore size distribution. IWC has 21.4% of the PEI polymer and JJW has 33% of the PEI polymer. (IWC is the same as JJW, but with less polymer). The point of this figure is to show the effect of polymer loading on porosity.

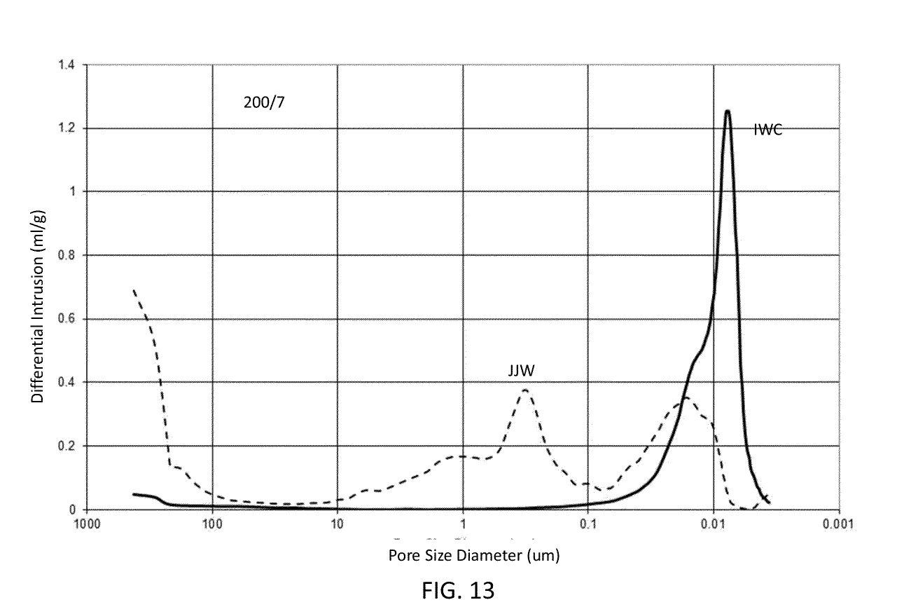

FIG. 13 is a graph illustrating pore size distribution of the JJW and IWC compositions with the same 200/7 geometry. As shown in FIG. 13, the JJW composition has 33% PEI and the IWC composition has 21.4% PEI (see Table 1). The JJW composition has 52% porosity and 0.7 cc/g pore volume. Both compositions have the 200/7 geometry. As shown, PEI in the batch increases macropores (>500 Å) generated in the final product and alters mesopore distribution (<500 Å). This control of pore size distribution of the final product using polymers and organics is relevant.

It should be understood that the present disclosure includes various aspects.

In a first aspect, the disclosure provides an absorbent structure for CO₂ capture comprising: a honeycomb substrate having a plurality of partition walls extending in an axial direction from an inlet end to an outlet end thereby forming a plurality of flow channels, wherein the honeycomb substrate comprises a powder component and a binder that are solidified; and a functional mer group dispersed throughout the powder component of the partition walls of the honeycomb substrate, wherein the functional mer group is positioned in and on the partition walls such that, when a gas stream containing CO₂ flows in the flow channels from the inlet end to the outlet end, the functional mer group absorbs the CO₂ by forming a coordinated bond that forms carbonate, bicarbonate, carbamates, or another coordinated or ionic compound with the CO₂.

In a second aspect, the disclosure provides a method of forming an absorbent structure for CO₂ capture comprising: dry blending a powder component and a binder into a mixture; adding a solution of a functional mer group and a solvent to the mixture to form a precursor, wherein the functional mer group absorbs CO₂ by forming a coordinated bond that forms carbonate, bicarbonate, carbamates, or other coordinated or ionic compound with CO₂; mulling the precursor; extruding the precursor to form a consolidated monolith having a plurality of partition walls extending in an axial direction from an inlet end to an outlet end thereby forming a plurality of flow channels; and removing the solvent from the consolidated monolith to form a honeycomb substrate.

In a third aspect, the disclosure provides a method of forming an absorbent structure for CO₂ capture comprising: forming a slurry comprising a powder component, a functional mer group, and a first solvent; removing the first solvent from the slurry to form individual grains of the powder component impregnated with the functional mer group, wherein the functional mer group absorbs CO₂ by forming a coordinated bond that forms carbonate, bicarbonate, carbamates, or other coordinated or ionic compound with CO₂; blending a precursor comprising the impregnated individual grains of the powder component, a binder, and a second solvent; extruding the precursor to form a consolidated monolith having a plurality of partition walls extending in an axial direction from an inlet end to an outlet end thereby forming a plurality of flow channels; and removing the second solvent from the consolidated monolith to form a honeycomb substrate.

In a fourth aspect, the disclosure provides the absorbent structure of the first aspect or the method of forming the absorbent structure of the second and third aspect, wherein the powder component comprises an inorganic oxide.

In a fifth aspect, the disclosure provides for the fourth aspect, wherein the inorganic oxide is selected from the group consisting of non-refractory alumina, an inorganic molecular silicate, a non-crystalline amorphous silica, a double-layered hydroxide, and combinations thereof.

In a sixth aspect, the disclosure provides for the fourth aspect, wherein the inorganic oxide is a zeolite.

In a seventh aspect, the disclosure provides for the sixth aspect, wherein the zeolite is selected from the group consisting of faujasites, X-type, A-type, β-type, and MFI-type.

In an eighth aspect, the disclosure provides the fifth aspect, wherein the non-refactory alumina is selected from the group consisting of alumina tri-hydroxides, boehmite, γ-alumina, ρ-alumina, and transition or activated alumina.

In a ninth aspect, the disclosure provides the fifth aspect, wherein the non-crystalline amorphous silica is selected from the group consisting of precipitated silica, silica gel, and mesoporous silica.

In a tenth aspect, the disclosure provides any of the first though third aspect, wherein the powder component is activated carbon.

In an eleventh aspect, the disclosure provides any of the first through tenth aspects, wherein an average surface area of the powder component is greater than 50 m²/g.

In a twelfth aspect, the disclosure provides any of the first through eleventh aspects, wherein an average surface area of the powder component is greater than 150 m²/g.

In a thirteenth aspect, the disclosure provides any of the first through twelfth aspects, wherein an average surface area of the powder component is from about 150 m²/g to about 1000 m²/g.

In a fourteenth aspect, the disclosure provides any of the first through thirteenth aspects, wherein an average pore size of the powder component is greater than 2 nanometers.

In a fifteenth aspect, the disclosure provides any of the first through fourteenth aspects, wherein an average pore size of the powder component is greater than 3 nanometers.

In a sixteenth aspect, the disclosure provides any of the first through fifteenth aspects, wherein an average pore size of the powder component is from about 4 nanometers to about 10 nanometers.

In a seventeenth aspect, the disclosure provides any of the first through sixteenth aspects, wherein the honeycomb substrate has a porosity from about 20% to about 90%.

In an eighteenth aspect, the disclosure provides any of the first through seventeenth aspects, wherein the functional mer group comprises an amine

In a nineteenth aspect, the disclosure provides any of the first through eighteenth aspects, wherein the amine is selected from a group consisting of polyethyleneimine, polyamidoamine, and polyvinylamine.

In a twentieth aspect, the disclosure provides any of the first through nineteenth aspects, wherein the binder comprises an organic or an inorganic polymer.

In a twenty-first aspect, the disclosure provides the twentieth aspect, wherein the binder comprises methyl cellulose.

In a twenty-second aspect, the disclosure provides any of the first through twenty-first aspect, wherein the honeycomb substrate is unsintered.

In a twenty-third aspect, the disclosure provides any of the second through twenty-second aspects, wherein the mixture further comprises a polymerizing agent and/or a cross-linking agent, and the polymerizing agent polymerizes the functional mer group and/or the cross-linking agent cross-links the functional mer group when thermally activated at an elevated temperature.

In a twenty-fourth aspect, the disclosure provides any of the second through twenty-third aspects further comprising activating the functional mer group by introducing a polymerization agent and/or a cross-linking agent to the honeycomb substrate.

In a twenty-fifth aspect, the disclosure provides any of the second through twenty-fourth aspects, wherein the solvent is removed from the consolidated monolith by heating the consolidated monolith to evaporate the solvent.

In a twenty-sixth aspect, the disclosure provides any of the second through twenty-fifth aspects, wherein when processing the consolidated monolith into the honeycomb substrate, a processing temperature is maintained below a decomposition temperature of the functional mer group.

In a twenty-seventh aspect, the disclosure provides any of the third through twenty-sixth aspects, wherein the first solvent is removed from the slurry by a spray drying process.

In a twenty-eighth aspect, the disclosure provides any of the third through twenty-seventh aspects, wherein the first solvent is removed from the slurry by a distillation process.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. An absorbent structure for CO₂ capture comprising:
a honeycomb substrate having a plurality of partition walls extending in an axial direction from an inlet end to an outlet end thereby forming a plurality of flow channels, wherein the honeycomb substrate comprises a powder component and a binder that are solidified; and
a functional mer group dispersed throughout the powder component of the partition walls of the honeycomb substrate, wherein the functional mer group is positioned in and on the partition walls such that, when a gas stream containing CO₂ flows in the flow channels from the inlet end to the outlet end, the functional mer group absorbs the CO₂ by forming a coordinated bond that forms carbonate, bicarbonate, carbamates, or another coordinated or ionic compound with the CO₂.

2. The absorbent structure for CO₂ capture of claim 1, wherein the powder component comprises an inorganic oxide.

3. The absorbent structure for CO₂ capture of claim 1, wherein the powder component is selected from the group consisting of non-refractory alumina, an inorganic molecular silicate, a non-crystalline amorphous silica, a double-layered hydroxide, zeolite and combinations thereof.

4. The absorbent structure for CO₂ capture of claim 3, wherein:
the zeolite is selected from the group consisting of faujasites, X-type, A-type, β-type, and MFI-type;
the non-refractory aluminia is selected from the group consisting of alumina tri-hydroxides, boehmite, γ-alumina, ρ-alumina, and transition or activated alumina; and
the non-crystalline amorphous silica is selected from the group consisting of precipitated silica, silica gel, and mesoporous silica.

5. The absorbent structure for CO₂ capture of claim 1, wherein the powder component is activated carbon.

6. The absorbent structure for CO₂ capture of claim 1, wherein an average surface area of the powder component is greater than 50 m²/g.

7. The absorbent structure for CO₂ capture of claim 6, wherein an average surface area of the powder component is from about 150 m²/g to about 1000 m²/g.

8. The absorbent structure for CO₂ capture of claim 1, wherein the honeycomb substrate has a porosity from about 20% to about 90%.

9. The absorbent structure for CO₂ capture of claim 1, wherein the functional mer group comprises an amine.

10. The absorbent structure for CO₂ capture of claim 9, wherein the amine is selected from a group consisting of polyethyleneimine, polyamidoamine, and polyvinylamine.

11. The absorbent structure for CO₂ capture of claim 1, wherein the honeycomb substrate is unsintered.

12. A method of forming an absorbent structure for CO₂ capture comprising:
dry blending a powder component and a binder into a mixture;
adding a solution of a functional mer group and a solvent to the mixture to form a precursor, wherein the functional mer group absorbs CO₂ by forming a coordinated bond that forms carbonate, bicarbonate, carbamates, or other coordinated or ionic compound with CO₂;
mulling the precursor;
extruding the precursor to form a consolidated monolith having a plurality of partition walls extending in an axial direction from an inlet end to an outlet end thereby forming a plurality of flow channels; and
removing the solvent from the consolidated monolith to form a honeycomb substrate.

13. The method of claim 12, wherein the mixture further comprises a polymerizing agent and/or a cross-linking agent, and the polymerizing agent polymerizes the functional mer group and/or the cross-linking agent cross-links the functional mer group when thermally activated at an elevated temperature.

14. The method of claim 12 further comprising activating the functional mer group by introducing a polymerization agent and/or a cross-linking agent to the honeycomb substrate.

15. The method of claim 12, wherein the solvent is removed from the consolidated monolith by heating the consolidated monolith to evaporate the solvent.

16. The method of claim 12, wherein when processing the consolidated monolith into the honeycomb substrate, a processing temperature is maintained below a decomposition temperature of the functional mer group.

17. The method of claim 12, wherein the solvent is an alcohol solution.

18. The method of claim 12, wherein the solvent comprises water.

19. The method of claim 12, further comprising homogenizing the precursor prior to extruding.

20. A method of forming an absorbent structure for CO₂ capture comprising:
forming a slurry comprising a powder component, a functional mer group, and a first solvent;
removing the first solvent from the slurry to form individual grains of the powder component impregnated with the functional mer group, wherein the functional mer group absorbs CO₂ by forming a coordinated bond that forms carbonate, bicarbonate, carbamates, or other coordinated or ionic compound with CO₂;
blending a precursor comprising the impregnated individual grains of the powder component, a binder, and a second solvent;
extruding the precursor to form a consolidated monolith having a plurality of partition walls extending in an axial direction from an inlet end to an outlet end thereby forming a plurality of flow channels; and
removing the second solvent from the consolidated monolith to form a honeycomb substrate.
